(19) United States
(12) Patent Application Publication
(10) Pub. No.: US 2012/0008614 A1
(43) Pub. Date: Jan. 12, 2012

(54) WIRELESS COMMUNICATION SYSTEM, TERMINAL APPARATUS, BASE STATION APPARATUS, CONTROL METHOD, PROGRAM, AND RECORDING MEDIUM

(76) Inventors: Isao Hirakawa, Osaka (JP); Yongming Liang, Shanghai (CN)

(21) Appl. No.: 13/255,521

(22) PCT Filed: Feb. 9, 2010
(86) PCT No.: PCT/JP2010/000801

§ 371 Date: Sep. 9, 2011

(30) Foreign Application Priority Data
Mar. 12, 2009 (JP) 2009-059842

(51) Int. Cl. H04W 92/00

(52) U.S. Cl. 370/338

(57) ABSTRACT

A wireless communication system of the present invention includes a plurality of cells in each of which a base station apparatus (BS) is provided, the base station apparatuses (BS) being connected to one another via a network, each of the base station apparatuses (BS), including: an interference quantity information storage section (29) for storing at least information on interference quantities of a signal transmitted, to a terminal apparatus in a corresponding one of the cells in which the each of the base station apparatuses is provided, from another cell different from the corresponding one of the cells; a transmission section (22) for notifying the information stored in the interference quantity information storage section (29) to the network; and a transmission method determination section (25) for determining, on the basis of the information on the interference quantities, transmission methods by which a signal is transmitted to the terminal apparatus. This makes it possible to reduce inter-cell interference in the terminal apparatus (BS) located in an adjacent cell by means of a simple process.

### TECHNICAL FIELD

The present invention relates to a wireless communication system, and to apparatuses such as a terminal apparatus and a base station apparatus which constitute the wireless communication system. In particular, the present invention relates to a wireless communication system in which inter-cell interference is reduced, and to apparatuses such as a terminal apparatus and a base station apparatus which constitute the wireless communication system.

### BACKGROUND ART

Recently, a wireless communication system has been required to use important techniques such as a high-speed transmission technique, a broadband system technique, and a technique for maintaining Quality of Service (QoS). The requirements are met by techniques such as Multiple Input Multiple Output (MIMO), Orthogonal Frequency Division Multiplexing (OFDM), Radio Resource Management (RRM), Carrier Aggregation (CA), Inter-Cell Interference Cancellation/Coordination (ICIC), and/or Coordinated MultiPoint (CoMP).

These techniques are employed by Long Term Evolution (LTE) that is Evolved Universal Terrestrial Radio Access (EUTRA), Long Term Evolution-Advanced (LTE-A) that has been developed from the Long Term Evolution (LTE), and the like (see Non-Patent Literatures 1, 2 and 3).

(1) How Channels of Uplink and Downlink are Configured in LTE

FIG. 8 is a view showing how channels are configured in LTE. In the LTE, a downlink (communication from a base station apparatus BS to a terminal apparatus UE) is made up of a Physical Control Format Indicator Channel (PCFICH), a Physical Hybrid ARQ Indicator Channel (PHICH), a Physical Multicast Channel (PMCH), a Physical Downlink Shared Channel (PDSCH), a Physical Downlink Control Channel (PDCCH), and a Physical Broadcast Channel (PBCH).

Other than the communication using the channels, the base station BS also transmits, to the terminal apparatus UE, (i) a synchronization signal (SCH: Synchronization Channel) that is a reference signal for synchronizing the terminal apparatus UE with the base station BS and (ii) a reference signal (RS: Reference Signal) used as a reference during measuring of a signal quality and demodulating of a received signal.

In the LTE, an uplink (communication from the terminal apparatus UE to the base station apparatus BS) is made up of a Random Access Channel (RACH), a Physical Uplink Shared Channel (PUSCH), and a Physical Uplink Control Channel (PUCCH).

Other than the communication using the channels, the terminal apparatus UE also transmits, to the base station BS, a reference signal (RS: Reference Signal) used as a reference during measuring of a signal quality and demodulating of a received signal.

(2) How a Downlink Signal Frame is Configured in LTE

FIG. 9 is a view schematically showing how a downlink signal frame is configured in the LTE. In FIG. 9, a lateral axis represents a frequency, and a longitudinal axis represents a time period. A downlink signal frame of the EUTRA includes a plurality of resource blocks. Each of the resource blocks includes a plurality of subcarriers in a direction of the frequency and a plurality of OFDM symbols in a direction of the time period.

Headmost one through four OFDM symbols in the respective resource blocks are used as a downlink control region. In the downlink control region, PCFICHs, PHICHs and PDCCHs are arranged. The PCFICHs are dispersedly arranged in the headmost OFDM symbols of respective subframes. Further, each of the PCFICHs includes information on the number of the OFDM symbols to be used as the downlink control region.

The terminal apparatus UE can specify the downlink control region by demodulating the PCFICHs. The PHICHs are dispersedly arranged over the downlink control region. Further, each of the PHICHs includes information on a request for retransmitting a signal that has been transmitted via the uplink.

A part of the downlink control region which part is not used as the PCFICHs and the PHICHs is used as a region where the PDCCHs are transmitted. The PDCCHs are also dispersedly arranged in the downlink control region.

The PDCCHs allocate a downlink resource to each terminal apparatus. Each terminal apparatus monitors the PDCCHs in the downlink control region. In a case where a PDCCH directed to the each terminal apparatus is transmitted to the each terminal apparatus, the each terminal apparatus demodulates the PDCCH. The PDCCHs include information on allocation of PDSCHs. The PDCCHs also include information on communication methods such as a demodulation method and a transmission diversity method that are employed by the PDSCHs.

Data is transmitted from the base station apparatus to the terminal apparatus, via the PDSCHs. The terminal apparatus receives data directed to the terminal apparatus, by demodulating a PDSCH allocated to received data. Further, data common to all the terminal apparatuses UE in addition to data inherent in the respective terminal apparatuses is transmitted via the PDSCHs. The PDCCHs similarly allocate a resource to the PDSCHs for transmitting the common data. The terminal apparatuses monitor the PDCCHs, demodulate a PDCCH common to all the terminal apparatuses in a case where the PDCCH is transmitted to the terminal apparatuses, and demodulate allocated PDSCHs on the basis of information obtained by the demodulation.

The downlink signal frame contains, other than the above signals, a reference signal that serves as a reference in a case where the terminal apparatuses demodulate the signals. Note that FIG. 9 omits the reference signal.

(3) As to Carrier Aggregation for Expanding a Band Width

A Component Carrier (CC) refers to an aggregation of a plurality of resource blocks shown in FIG. 10, and is used in a signal frame of LTE. A technique of carrier aggregation, in which a plurality of component carriers are simultaneously used, is employed in the LTE-Advanced.

FIG. 10 is a view conceptually showing the carrier aggregation. Simultaneous usages of a plurality of carriers allow for rapid communications. Examples of the carrier aggregation encompass (i) aggregation of adjacent component carriers, (ii) aggregation of separated component carriers, and a combination of the aggregations (i) and (ii). Note that band widths of respective component carriers to be aggregated can be different from each other.

(4) As to Coordinated Multipoint Communication

According to the coordinated multipoint communication, signals are transmitted from a plurality of base station apparatuses. This allows (i) an improvement in reception quality due to a transmission diversity effect and (ii) an increase in transmission quantity due to spatial multiplexing. In order to improve a reception property of a terminal apparatus located at a cell edge, the signals are simultaneously transmitted from the plurality of base stations, and the terminal apparatus receives the signals from the plurality of base stations.

FIG. 11 is a view schematically showing how coordinated multipoint communication is carried out. A terminal apparatus UE700 located at a cell edge receives a signal mainly from a base station apparatus BS700, and also receives signals from peripheral base station apparatuses BS701 and BS702.

In general, a long distance between the terminal apparatus UE700 and the base station apparatus BS700 causes a deterioration in reception property of the terminal apparatus UE700. However, the terminal apparatus UE700 also receives the signals from the base station apparatuses BS701 and BS702. This makes it possible to suppress the deterioration in the reception property. Similarly, a terminal apparatus UE701 mainly communicates with the base station apparatus BS701. Note, however, that the terminal apparatus UE701 does not carry out coordinated multipoint communications with the base station apparatuses BS700 and BS702 because the terminal apparatus UE701 is not far from the base station BS701. The location and the number of base station(s) to be used during coordinated multipoint communication(s) are varied as appropriate depending on the location of a terminal apparatus UE. The base station apparatuses are connected to one another via a communication line called backhaul.

For example, data transmitted to the terminal apparatus UE700 includes (i) data transmitted from the base station apparatus 700 and (ii) data transmitted from the BS701 via the backhaul. The backhaul can be a wired line or a wireless line. In a case where the backhaul is a wireless line, an in-band signaling in which a frequency band identical to that used during a signal communication is employed or an out-of-band signaling in which a frequency band different from that used during the signal communication is employed is applied.

### CITATION LIST

### Non-Patent Literature

Non-Patent Literature 1

3GPP TS 36.211, V8.5.0 (2008-12), Technical Specification Group Radio Access Network; Evolved Universal Terrestrial Radio Access (E-UTRA); Physical Channels and Modulation (Release 8)

Non-Patent Literature 2

3GPP TS 36.814, V1.0.0 (2009-02), 3rd Generation Partnership Project; Technical Specification Group Radio Access Network; Further Advancements for E-UTRA Physical Layer Aspects (Release 9)

Non-Patent Literature 3

“Text proposal for capturing agreements on support of wider bandwidths”, 3GPP TSG RAN WG1 Meeting #55, Nokia, Nokia Siemens Networks, Prague, Czech Republic, Nov. 10-14, 2008, R1-084706

Non-Patent Literature 4

“A Hybrid Concept of ICIC and CoMP for LTE-A: Initial Evaluation”, 3GPP TSG RAN WG1 Meeting #56bis, CHTTL, ITRI, Athens, Greece, Feb. 9-13, 2009, R1-090956

### SUMMARY OF INVENTION

### Technical Problem

An inter-cell interference cancellation system is fundamental to an LTE-A system. In a case where a terminal apparatus does not carry out coordinated multipoint communication, a terminal apparatus is disturbed by an adjacent cell. FIG. 12 is a view showing an example of inter-cell interference in an LTE-A system. A terminal apparatus UE710 located at a cell edge receives a signal from a base station apparatus BS700, but does not carry out a coordinated multipoint communication. Further, a terminal apparatus UE711 also located at a cell edge receives a signal from a base station apparatus BS701, and the signal interferes with the terminal apparatus UE710 located in a cell adjacent to a cell in which the terminal apparatus UE711 is located.

In order to address the problem, there is known, for example, Fractional Frequency Reuse (FFR) in which a frequency resource is divided to be used for each cell. FIG. 13 is a view showing an example of the FFR. In FIG. 13, a frequency region for the FFR is divided into three regions of f_1, f_2 and f_3, and each of frequency resources is used for a corresponding one of cells. A terminal apparatus located at each cell edge is allocated such that the terminal apparatus uses a corresponding one of the frequency resources. This makes it possible to prevent the inter-cell interference.

However, in a case of the FFR, specific frequency resources are merely permitted to be used in one (1) cell. This therefore causes a decrease in throughput of an entire system.

Meanwhile, in a case of the coordinated multipoint communication, an interference signal can be used as a signal directed to a terminal apparatus itself. This brings about an effect of preventing the interference, and further brings about a diversity effect of a communication signal.

However, in the case of the coordinated multipoint communication, one (1) resource can be used during communication with merely one (1) terminal apparatus, although a plurality of cells originally allow signals to be transmitted to different terminal apparatuses. This still causes a problem of decrease in throughput of the entire system. Further, since it is not possible to stop transmitting signals from the cells, cells other than cells that carry out the coordinated multipoint communications are still interfered even if it was possible to prevent the cells that carry out the coordinated multipoint communications from being interfered.

In order to address the problems, there has been proposed a technique for employing the coordinated multipoint communication and the FFR in combination in accordance with a situation (see Non-Patent Literature 4). According to the technique, (i) a Signal to Interference and Noise Power Ratio (SINR) obtained in a case where a terminal apparatus carries out the coordinated multipoint communication and (ii) an SINR obtained in a case where such a terminal apparatus carries out the FFR, are calculated. Further, the terminal apparatus dynamically determines whether to perform the coordinated multipoint communication or the FFR on the basis of a result obtained by comparing the SINRs (based on which of the SINRs is larger).

However, according to the technique, it is necessary to calculate (i) the SINR obtained in the case where the terminal apparatus carries out the coordinated multipoint communication and (ii) the SINR obtained in the case where such a terminal apparatus carries out the FFR. This causes a problem that a necessary process is complicated.

The present invention was made in view of the problems, and an object of the present invention is to provide a wireless communication system, a terminal apparatus, a base station apparatus, a control method, a program and a recording medium, in which an occurrence of inter-cell interference in terminal apparatuses located in adjacent cells is reduced by a simple process.

### Solution to Problem

In order to attain the object, a wireless communication system of the present invention is a wireless communication system including a plurality of cells in each of which a base station apparatus is provided, the base station apparatuses being connected to one another via a network,

each of the base station apparatuses, including:
storage means for storing at least information on interference quantities of a signal transmitted, to a terminal apparatus in a corresponding one of the cells in which the each of the base station apparatuses is provided, from another cell different from the corresponding one of the cells;
notification means for notifying the information stored in the storage means to the network; and
setting means for setting, on the basis of the information on the interference quantities, transmission methods by which a signal is transmitted to the terminal apparatus.

In order to attain the object, a control method of the present invention is a method for controlling a wireless communication system which includes a plurality of cells in each of which a base station apparatus is provided, the base station apparatuses being connected to one another via a network,

said method including the steps of:

storing information on interference quantities of a signal transmitted from another cell different from a cell in which the terminal apparatus is provided;

notifying the information stored in the storage means to the network; and

setting, on the basis of the information on the interference quantities, transmission methods by which the signal is transmitted to the terminal apparatus.

In order to attain the object, base station apparatuses of the present invention are base station apparatuses, which constitute a wireless communication system, including a plurality of cells in each of which a base station apparatus is provided, the base station apparatuses being connected to one another via a network,

each of the base station apparatuses, including:
storage means for storing at least information on interference quantities of a signal transmitted, to a terminal apparatus in a corresponding one of the cells in which the each of the base station apparatuses is provided, from another cell different from the corresponding one of the cells;
notification means for notifying the information stored in the storage means to the network; and
setting means for setting, on the basis of the information on the interference quantities, transmission methods by which the signal is transmitted to the terminal apparatus.

In order to attain the object, a terminal apparatus of the present invention is a terminal apparatus, for use in a wireless communication system which includes a plurality of cells in each of which a base station apparatus is provided, the base station apparatuses being connected to one another via a network,

the terminal apparatus, including:
measurement means for measuring interference quantities of a signal transmitted from another cell different from a cell in which the terminal apparatus is provided; and
transmission means for transmitting information on the interference quantities thus measured to a corresponding one of the base station apparatuses.

According to the above configuration, each of the base station apparatuses included in the wireless communication system notifies, to other base station apparatuses different from the each of the base station apparatuses via the network, information on interference quantities of a signal transmitted to a terminal apparatus that communicates with the each of the base station apparatuses. The information is obtained by measuring by the terminal apparatus itself or by estimating by the each of the base station apparatuses. The each of the base station apparatuses determines (changes) the transmission methods by which the signal is transmitted to the terminal apparatus, on the basis of the information on the interference quantities transmitted from the terminal apparatus and/or the information notified by the other base stations different from the each of the base station apparatuses. It is accordingly possible to properly determine a transmission method that yields an effect of reducing an occurrence of the interference quantities in view of the information on the interference quantities.

As described above, by the wireless communication system of the present invention, it is possible to reduce inter-cell interference in terminal apparatuses located in adjacent cells by with a simple process without carrying out a complicated process such as a process employed in a conventional technique.

Note that the present invention encompasses a program for causing a computer to execute the method for controlling the wireless communication system, and a computer-readable recording medium in which the program is stored.

For a fuller understanding of the nature and advantages of the invention, reference should be made to the ensuing detailed description taken in conjunction with the accompanying drawings.

### Advantageous Effects of Invention

A wireless communication system of the present invention makes it possible to decrease, with a simple process, inter-cell interference in a terminal located in an adjacent cell.

### BRIEF DESCRIPTION OF DRAWINGS

FIG. 1 is a view showing an example of a terminal apparatus in accordance with First Embodiment of the present invention.

FIG. 2 is a block diagram showing an example of a principal configuration of a base station apparatus in accordance with the present embodiment.

FIG. 3 is a view showing an example of a method for creating interference quantity information in accordance with the present embodiment.

FIG. 4 is a flowchart showing how to select, in the present invention, a transmission method employed to decrease interference quantity.

FIG. 5 is a view showing frequency regions employed for respective cells constituting a system of the present embodiment.

FIG. 6 is a view showing a wireless communication system in accordance with another embodiment of the present invention.

FIG. 7 is a block diagram showing a principal configuration of another terminal apparatus in accordance with the present invention.

FIG. 8 is a view showing how channels are configured in LTE.

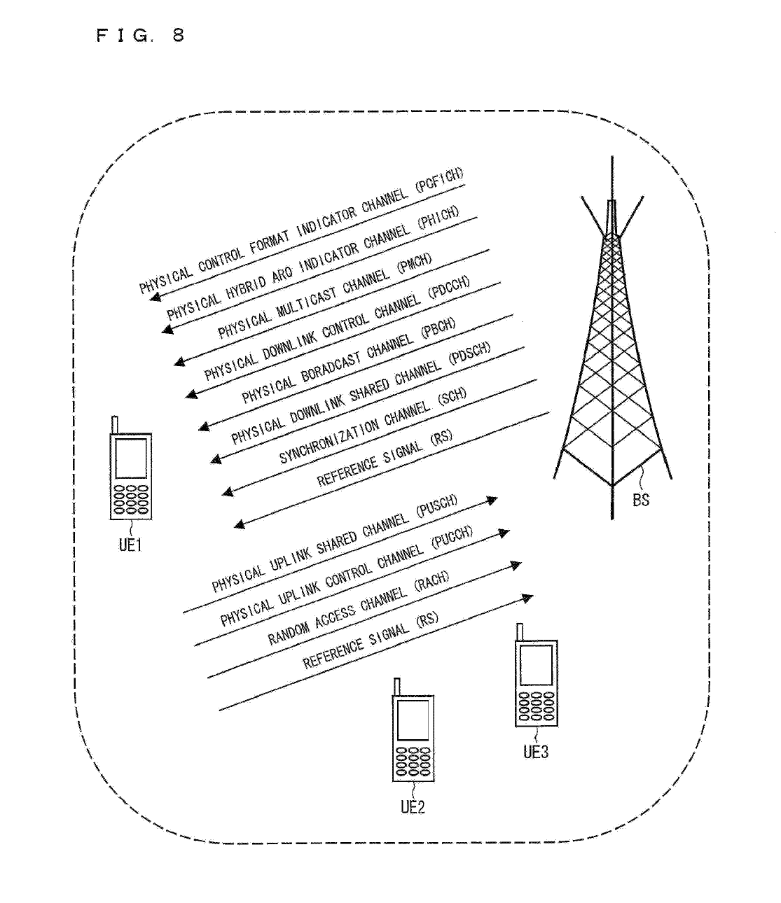

FIG. 9 is a view schematically showing how a downlink signal frame is configured in LTE.

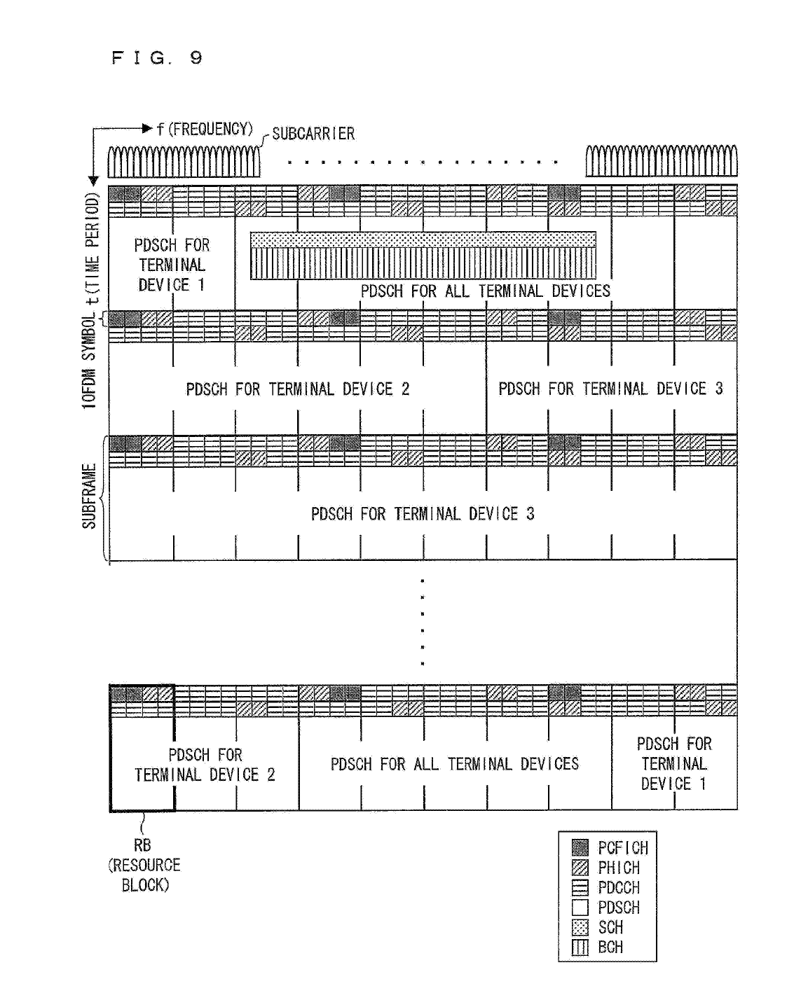

FIG. 10 is a view conceptually showing carrier aggregation.

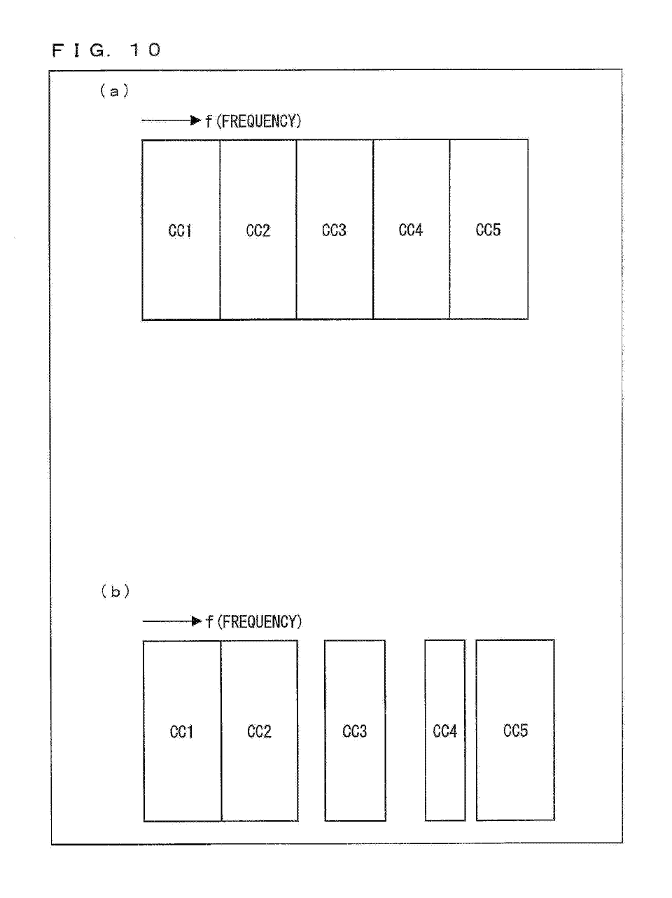

FIG. 11 is a view schematically showing how coordinated multipoint communication is carried out.

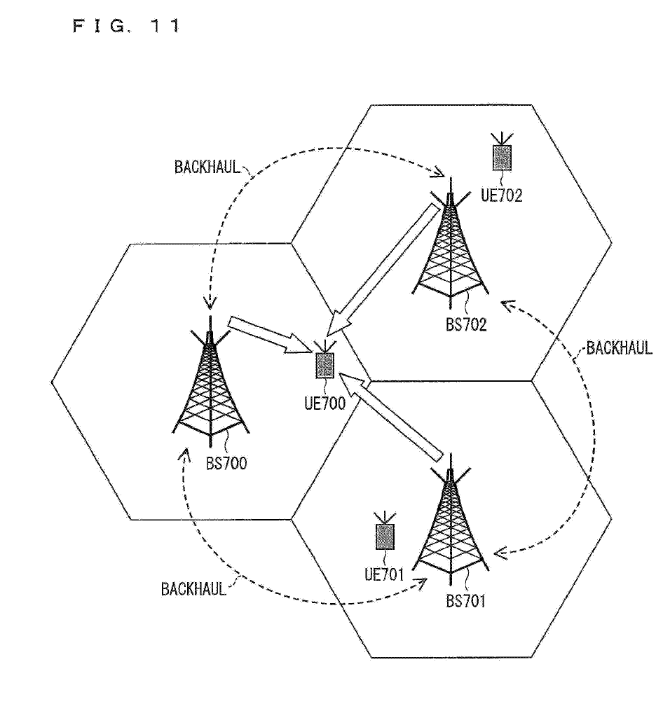

FIG. 12 is a view showing an example of inter-cell interference in an LTE-A system.

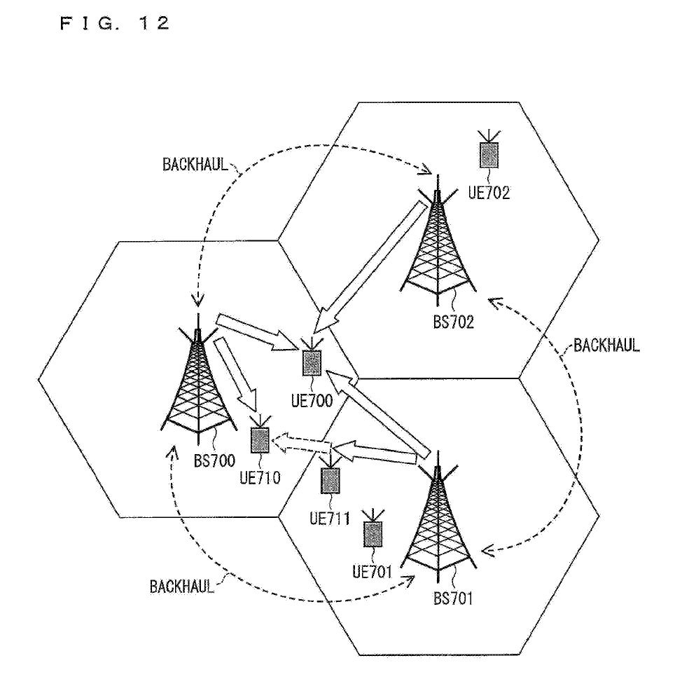

FIG. 13 is a view showing an example of FFR.

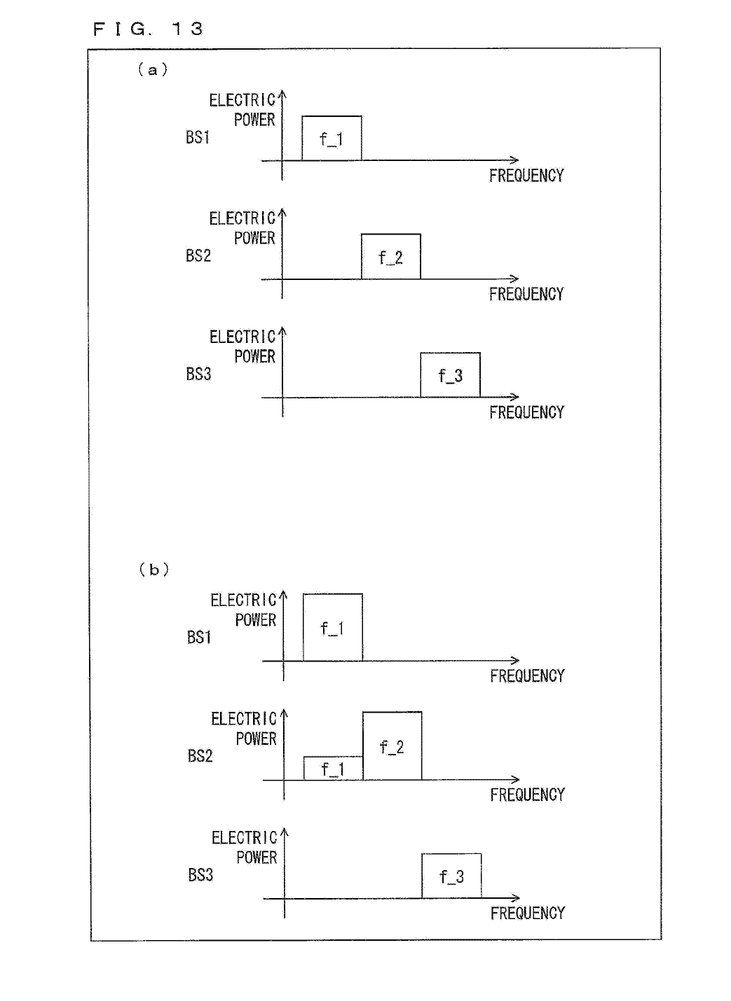

### DESCRIPTION OF EMBODIMENTS

### First Embodiment

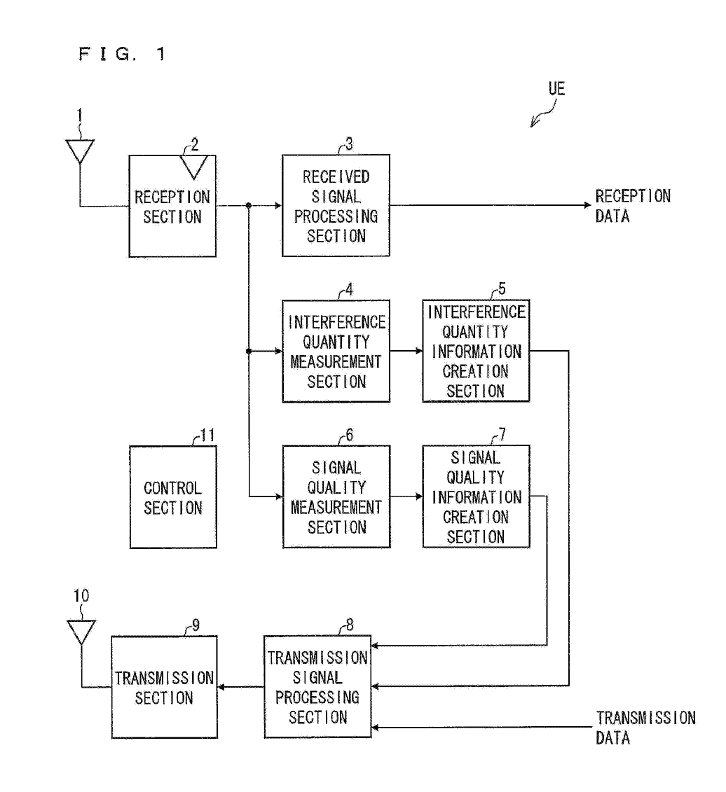

The following describes an embodiment of the present invention with reference to FIGS. 1 through 5.

A wireless communication system of the present invention includes a plurality of cells in which base station apparatuses BS are provided (later described in detail). Each of the cells includes at least one base station apparatus BS. A terminal apparatus UE enters and exits each of the cells. A terminal apparatus UE located in a cell communicates mainly with a base station apparatus BS provided in the cell, and also communicates, in accordance with a situation, with a base station apparatus BS provided in another cell. The base station apparatuses BS are connected to one another via a specific inter-base station network, which corresponds to a network recited later in CLAIMS).

(Configuration of Terminal Apparatus UE)

FIG. 1 is a view showing an example of a terminal apparatus UE in accordance with First Embodiment of the present invention. As shown in FIG. 1, the terminal apparatus UE includes a reception antenna 1, a reception section 2, a reception signal processing section 3, an interference quantity measurement section (measurement means) 4, an interference quantity information creation section 5, a signal quality measurement section 6, a signal quality information creation section 7, a transmission signal processing section 8, a transmission section (transmission means) 9, a transmission antenna 10, and a control section 11.

A base station apparatus BS (later described) transmits a downlink signal (downlink channel) to the terminal apparatus UE. In the terminal apparatus UE, the reception section 2 receives the downlink signal via the reception antenna 1, and then supplies the downlink signal to the reception signal processing section 3. The reception signal processing section 3 carries out a process such as demodulation of the downlink signal to reception data. The reception section 2 also supplies the downlink signal to the interference quantity measurement section 4. The interference quantity measurement section 4 measures interference quantity of a downlink signal supplied from another cell, and then supplies the interference quantity to the interference quantity information creation section 5. The interference quantity information creation section 5 creates, on the basis of the interference quantity, interference quantity information to be reported to the base station apparatus BS, and then supplies the interference quantity information to the transmission signal processing section 8. Note that the interference quantity information creation section 5 creates pieces of interference quantity information for respective resource blocks, respective subbands, and respective component carriers. The interference quantity information is later described in detail.

Further, the reception section 2 also supplies the downlink signal to the signal quality measurement section 6. The signal quality measurement section 6 measures a signal quality of the downlink signal, and then supplies the signal quality to the signal quality information creation section 7. The signal quality information creation section 7 creates, on the basis of the signal quality, signal quality information to be reported to the base station apparatus BS, and then supplies the signal quality information to the transmission signal processing section 8.

The transmission signal processing section 8 creates an uplink signal by multiplexing the interference quantity information, the signal quality information, and other transmission data, and then supplies the unlink signal to the transmission section 9. The transmission section 9 transmits the uplink signal via the transmission antenna 10.

The control section 11 controls operations of all the sections included in the terminal apparatus UE.

(Configuration of Base Station Apparatus BS)

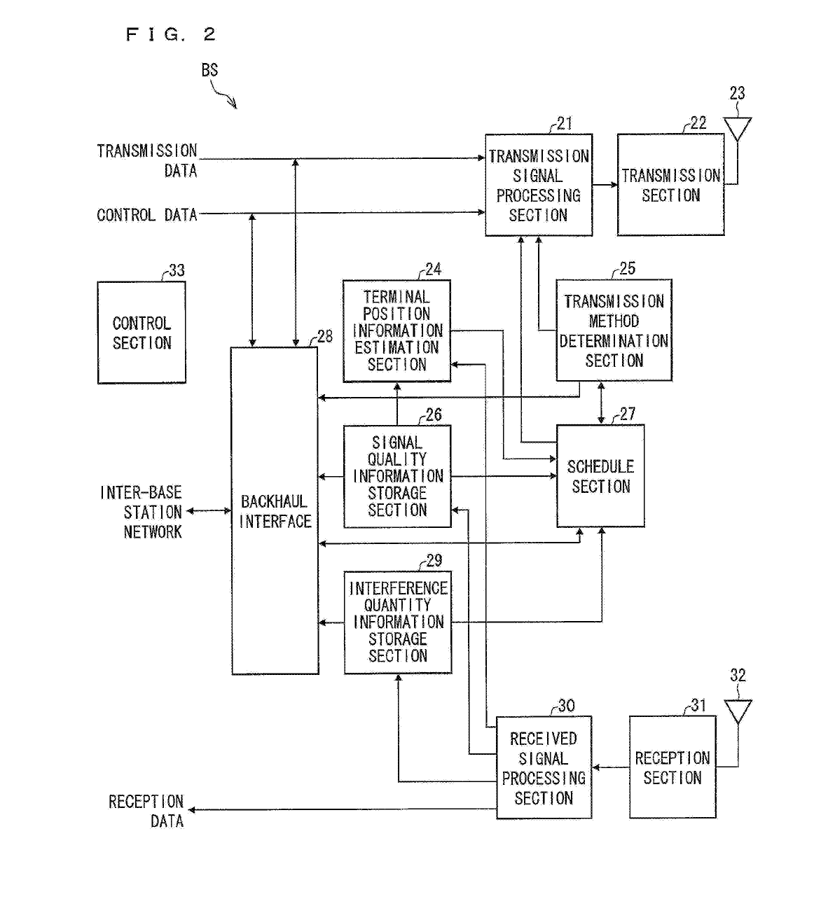

FIG. 2 is a block diagram showing an example of a principal configuration of a base station apparatus BS in accordance with the present embodiment. As shown in FIG. 2, the base station apparatus BS includes a transmission signal processing section 21, a transmission section (notification means) 22, a transmission antenna 23, a terminal position information estimation section (estimation means) 24, a transmission method determination section (setting means and determination means) 25, a signal quality information storage section 26, a schedule section (control means) 27, a backhaul interface 28, an interference quantity information storage section (storage means) 29, a reception signal processing section 30, a reception section 31, a reception antenna 32, and a control section 33.

As described above, the terminal apparatus UE transmits the uplink signal (uplink channel) to the base station apparatus BS. In the base station apparatus BS, the reception section 31 receives the uplink signal via the reception antenna 32, and then supplies the uplink signal to the reception signal processing section 30. The reception signal processing section 30 carries out a process such as demodulation of the uplink signal to reception data. The interference quantity information and the signal quantity information, which are multiplexed in the uplink signal, are separated by the reception signal processing section 30. The reception signal processing section 30 supplies the interference quantity information to the interference quantity information storage section 29, and supplies the signal quality information to the signal quality information storage section 26. The storage sections 29 and 26 store respective pieces of information thus supplied. The reception signal processing section 30 further transmits the interference quantity information to an inter-base station network via the backhaul interface 28.

The terminal position information estimation section 24 reads out the signal quality information stored in the signal quality information storage section 26, and obtains positional information on where the terminal apparatus US is located, the positional information being transmitted from the terminal apparatus UE via the reception signal processing section 30. The terminal position information estimation section 24 estimates, on the basis of these pieces of information, where the terminal apparatus UE is located.

The backhaul interface 28 exchanges, with a central control center and another base station apparatus BS via the inter-base station network, not only the interference quantity information but also transmission data used to carry out a coordinated multipoint communication, control information for decreasing interference, and schedule information of the terminal apparatus UE.

The transmission method determination section 25 reads out (i) the interference quantity information stored in the interference quantity information storage section 29 and (ii) the signal quality information stored in the signal quality information storage section 26. The transmission method determination section 25 further obtains interference quantity information and the like transmitted from another base station apparatus BS via the backhaul interface 28. Thus, the transmission method determination section 25 determines transmission methods for respective frequency regions on the basis of the pieces of information. Specifically, the transmission method determination section 25 determines whether to carry out the coordinated multipoint communication so as to decrease interference in each of the frequency regions. Alternatively, the transmission method determination section 25 determines to apply a transmission method determined by the central control center to each of the frequency regions. The transmission method determination section 25 further coordinates with another base station apparatus BS or the central control center, via the backhaul interface 28.

The schedule section 27 schedules the downlink signal to be transmitted to the terminal apparatus UE on the basis of (i) the transmission method, determined for each of the frequency regions by the transmission method determination section 25, which allows a decrease in interference and (ii) schedule information to be referred by the terminal apparatus UE when the terminal apparatus UE communicates with another base station apparatus BS. The schedule section 27 further determines whether or not a terminal apparatus UE which is scheduled in a frequency region where the coordinated multipoint communication is to be carried out carries out the coordinated multipoint communication, on the basis of terminal position estimation information supplied from the terminal position information estimation section 24. Meanwhile, the schedule section 27 determines whether to transmit the downlink signal to a terminal apparatus UE which is scheduled in a frequency region where no coordinated multipoint communication is carried out, so as to decrease an occurrence of interference in other cells. In a case where the downlink signal is transmitted, the schedule section 27 also determines whether to decrease transmission electric power and the like so as to decrease the occurrence of the interference in the other cells.

The transmission signal processing section 21 creates the above-described downlink signal, and then multiplexes the downlink signal with control information. Then, the transmission signal processing section 21 transmits the downlink signal thus multiplexed, via the transmission section 22 and the transmission antenna 23 in accordance with a schedule defined by the schedule information supplied from the schedule section 27.

The control section 33 controls operations of the entire sections included in the base station apparatus BS.

(Creation of Downlink Interference Quantity Information)

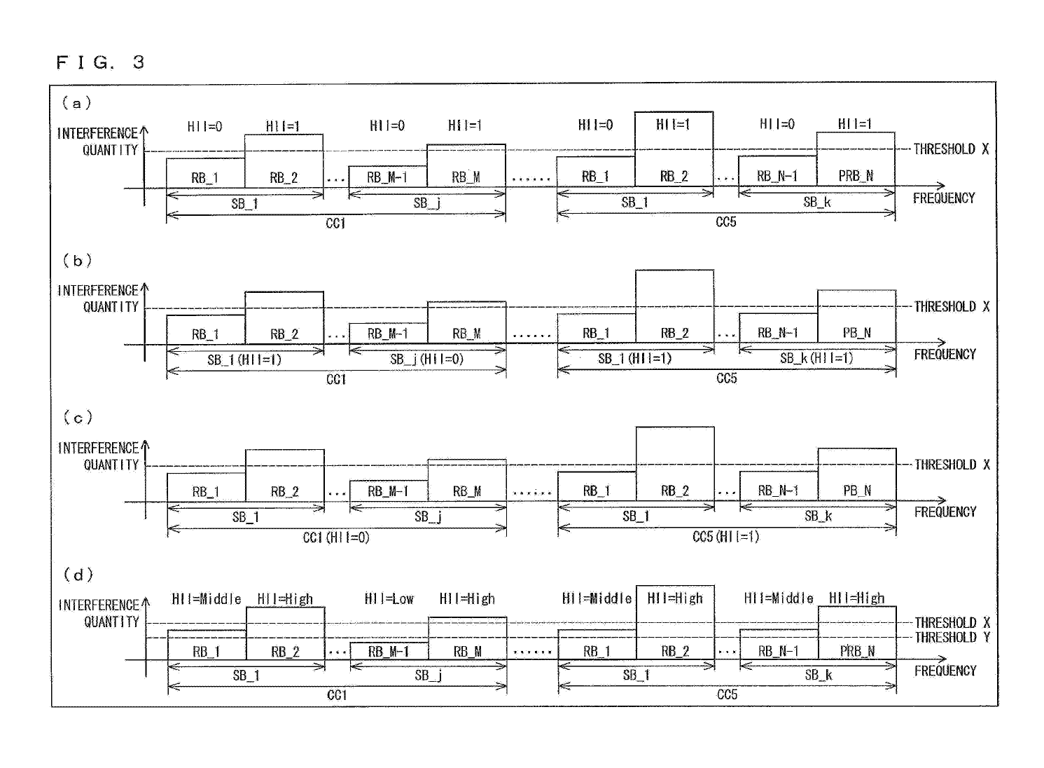

The following describes in detail creation of downlink interference quantity information. FIG. 3 is a view showing an example of a method for creating interference quantity information in accordance with the present embodiment.

The interference quantity measurement section 4 of the terminal apparatus UE measures interference quantities for the respective frequency regions to be measured. The respective interference quantities thus measured are quantized by being compared with a predetermined threshold. The threshold can be a single threshold or a plurality of thresholds. In a case where the threshold is a single threshold, the interference quantities can be represented by 1 bit (binary). This makes it possible to reduce information quantity to be transmitted to the base station apparatus BS. Meanwhile, in a case where the threshold is a plurality of thresholds, the base station apparatus BS can obtain more detailed interference quantity information though the information quantity is increased.

The interference quantity measurement section 4 can measure pieces of interference quantity information for respective resource blocks or for respective subbands each of which includes a plurality of resource blocks. Alternatively, the interference quantity measurement section 4 can measure the pieces of interference quantity information for respective component carriers in a carrier component aggregation transmission method, in a case where a carrier aggregation transmission method is employed. Further, the interference quantity measurement section 4 can measure the pieces of interference quantity information for the respective frequency regions employed for measuring the signal quality.

In a case where the signal qualities are measured for the respective frequency regions, the terminal apparatus UE measures transmission channel situations of the downlink signal for the respective frequency regions. Further, the transmission methods are changed for the respective frequency regions just as is the case of measurements of the transmission channel situations of the downlink signal. When the terminal apparatus UE transmits, to the base station apparatus BS, the signal quality information and the interference quantity information together, it becomes possible to decrease quantity of information on the frequency regions.

The pieces of interference quantity information measured for the respective frequency regions are transmitted to the base station apparatus BS. Note that it is not always necessary that the interference quantities are measured for the respective frequency regions just as is the case of transmission to the base station apparatus. For example, the interference quantities are measured for the respective resource blocks, meanwhile the pieces of interference quantity information are transmitted to the base station apparatus BS for the respective subblocks.

Note that the quantity of the pieces of interference quantity information stored at one time in the interference quantity information storage section 29 of the base station apparatus BS is not necessarily coincide with the quantity of the pieces of interference quantity information transmitted at one time from the terminal apparatus UE. Note also that the quantity of the pieces of interference quantity information transmitted at one time to the inter-base station network via the backhaul interface 28 by the base station apparatus BS is not necessarily coincide with the quantity of the pieces of interference quantity information transmitted at one time from the terminal apparatus UE or the quantity of the pieces of interference quantity information stored at one time in the interference quantity information storage section 29. An increase in the interference quantity information to be stored at one time and to be transmitted at one time allows a decrease in storage quantity and information quantity to be exchanged between the base stations.

(Flow of Selecting a Transmission Method)

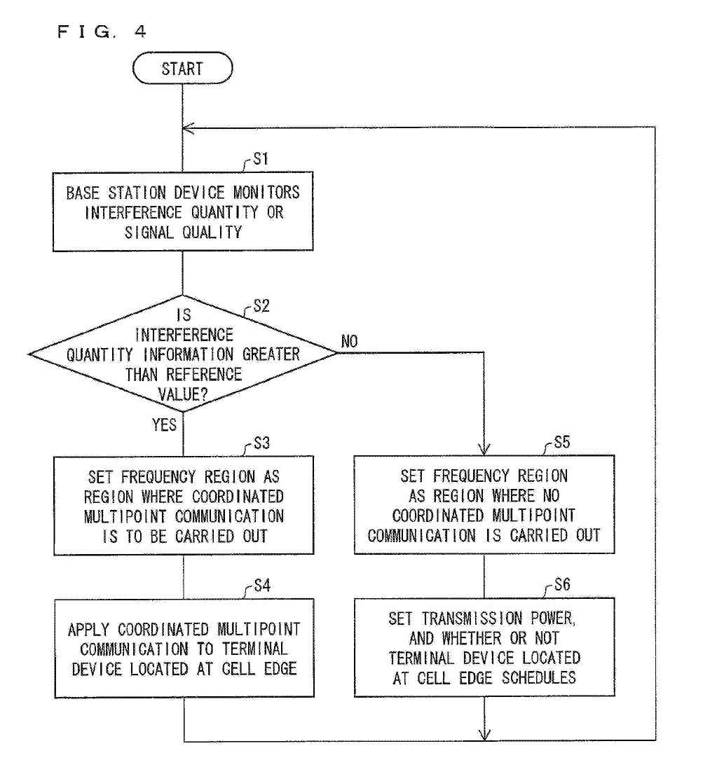

FIG. 4 is a flowchart showing how to select, in the present invention, a transmission method employed to decrease the interference quantity. Firstly, the base station apparatus BS monitors the interference quantity information received from the terminal apparatus UE or the interference quantity information estimated by the base station apparatus BS itself (step S1). Thereafter, the pieces of interference quantity information are compared with respective reference values for the respective frequency regions to be controlled (step S2). In a case where a piece of interference quantity information is greater than a corresponding reference value, a corresponding frequency region is set as a frequency region where the coordinated multipoint communication is to be carried out (step S3). Thereafter, the coordinated multipoint communication is applied to a terminal apparatus BS which is located at a cell edge and which is scheduled in a target frequency region (step S4). Meanwhile, in a case where the piece of interference quantity information is smaller than the corresponding reference value, the corresponding frequency region is set as a region where no coordinated multipoint communication is carried out (step S5). Thereafter, the terminal apparatus BS, which is located at the cell edge and which is scheduled in the target frequency region, transmits a signal, transmits the signal with reduced electric power, or does not schedule, in view of a situation of another terminal apparatus UE which is located in another cell (step S6).

(Frequency Region to be Used)

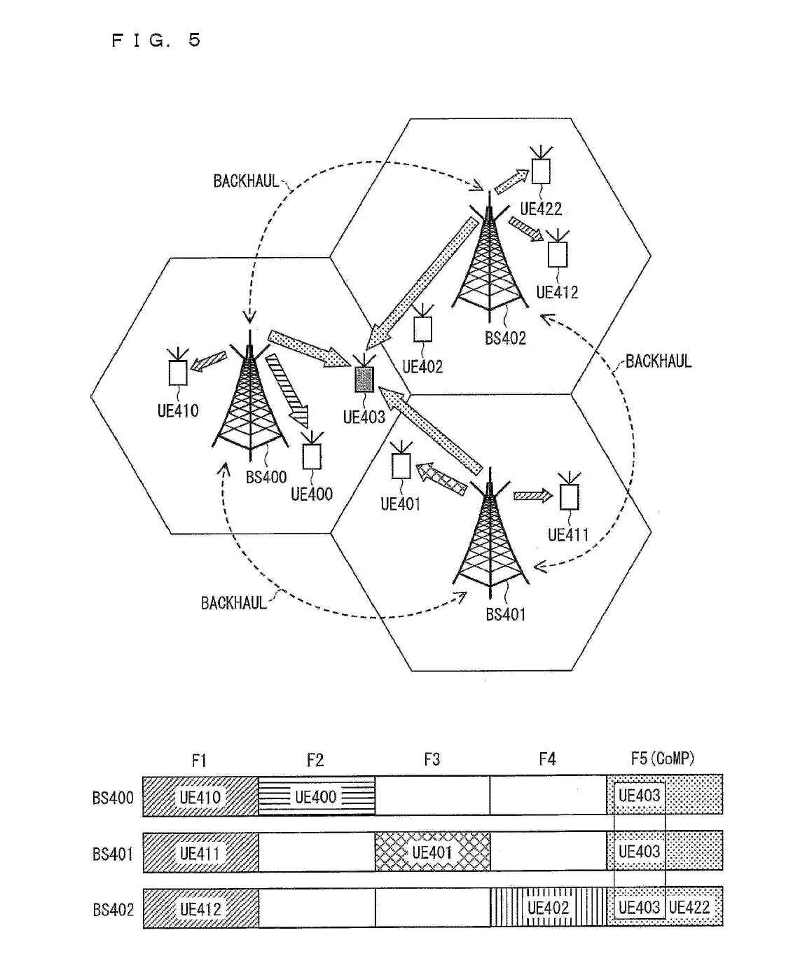

FIG. 5 is a view showing frequency regions to be employed for respective cells constituting a system of the present embodiment. Terminal apparatuses UE included in the respective cells measure respective interference quantities and respective signal qualities, and supply pieces of information on results obtained by the respective measurements to base station apparatuses BS included in the respective cells. The base station apparatuses BS compare the respective interference quantities and the respective signal qualities with respective predetermined reference values. This causes the terminal apparatuses UE to coordinate with a base station apparatus BS included in another cell. In a case where, as results of the coordination, base station apparatuses BS400 through BS402 set a frequency region F5 as a frequency region in which the coordinated multipoint communication is to be carried out, each of the base station apparatuses BS400 through BS402 schedules, in the frequency region F5, a terminal apparatus UE403 located at a cell edge, and transmits a corresponding downlink signal in accordance with the coordinated multipoint communication.

Each of the base station apparatuses BS applies Fractional Frequency Reuse (FFR) to terminal apparatuses UE (such as UE400, UE401, and UE402) which are scheduled in frequency regions other than the frequency region F5. Further, terminal apparatuses (such as UE410, UE411 and UE412) that are not located at their respective cell edges can be scheduled in an identical frequency region. Since these terminal apparatuses UE are not located at their respective cell edges, transmission power can be reduced. This makes it possible to decrease inter-cell interference.

Further, it is, for example, possible not to apply the coordinated multipoint communication to a terminal apparatus UE (such as UE422), that can transmit a signal with reduced transmission power because the terminal apparatus UE is not located at a cell edge, out of the terminal apparatuses UE that is scheduled in the frequency region F5 which is set as the frequency region where the coordinated multipoint communication is to be carried out. This is true for frequency regions to which the FFR is applied.

The frequency region can be (i) a resource block, (ii) a subband obtained by dividing a component frequency, or (iii) a component carrier. The smaller the frequency region is, the more flexible scheduling can be ensured. Meanwhile, the more the frequency region is, the smaller the information quantity exchanged between the base stations becomes.

It is often the case that a line speed in a backhaul is generally lower than a communication speed between a base station apparatus BS and a terminal apparatus UE. Accordingly, an increase in a frequency region allows a reduction in load on a backhaul line. According to the present embodiment, the frequency region can be set as appropriate in accordance with a situation of the load on the backhaul line. It is therefore possible to enhance a flexibility of an entire system.

(Effect Attained by the Present Invention)

As described above, in the wireless communication system of the present embodiment, whether to carry out the coordinated multipoint communications is determined for the respective frequency regions on the basis of the respective pieces of interference quantity information and the respective pieces of signal quality information. Further, in the wireless communication system of the present embodiment, whether to carry out the coordinated multipoint communication and whether to control the transmission power are determined, on the basis of where the terminal apparatus UE is located. This brings about (i) an effect of capable of simply operating the terminal apparatus UE and (ii) an effect of capable of reducing the load on the backhaul line. On this account, by employing the system of the present invention described above, it is possible to (i) simplify operations of the terminal apparatus UE and the network and (ii) efficiently reduce the interference.

### Second Embodiment

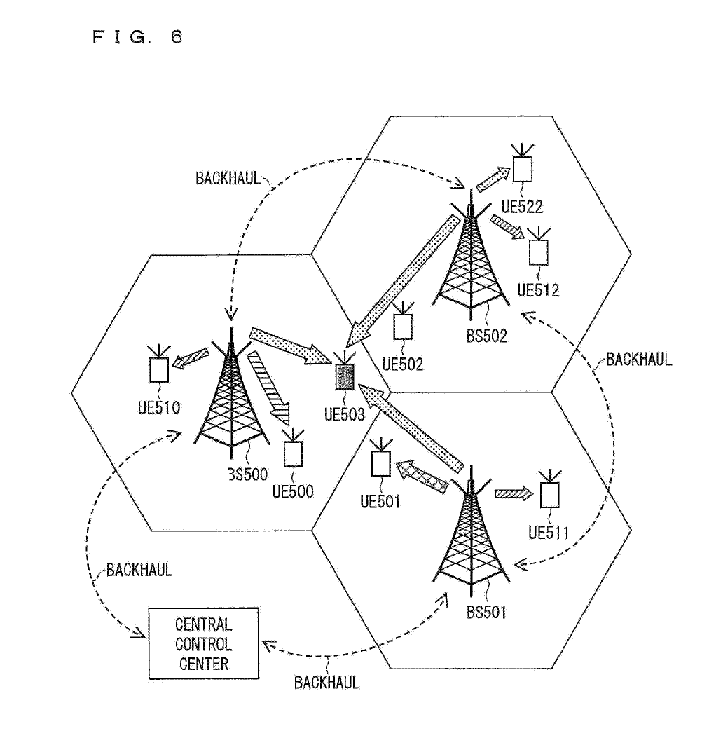

The following describes Second Embodiment of the present invention with reference to FIG. 6. In the present embodiment, identical reference numerals are assigned to members which are common to First Embodiment and Second Embodiment, and descriptions of such members are omitted here.

FIG. 6 is a view showing a wireless communication system in accordance with another embodiment of the present invention. In the wireless communication system shown in FIG. 6, transmission methods for respective frequency regions which methods are carried out among base stations BS500 through BS502 are not determined on the basis of coordination among the base stations BS500 through BS502, but determined by a central control center. In general, the coordination should be repetitively carried out among a plurality of base stations BS so as to optimize settings among the plurality of base stations BS. This causes an increase in load on a backhaul line. As is early described, in a case where a line speed used in the backhaul line is slow, such an increased load on the backhaul line causes a major problem.

According to the system of the present embodiment, the transmission methods for the respective frequency regions are determined by the central control center only. It is therefore possible to quickly set the transmission methods while reducing information quantity of the backhaul line.

### Third Embodiment

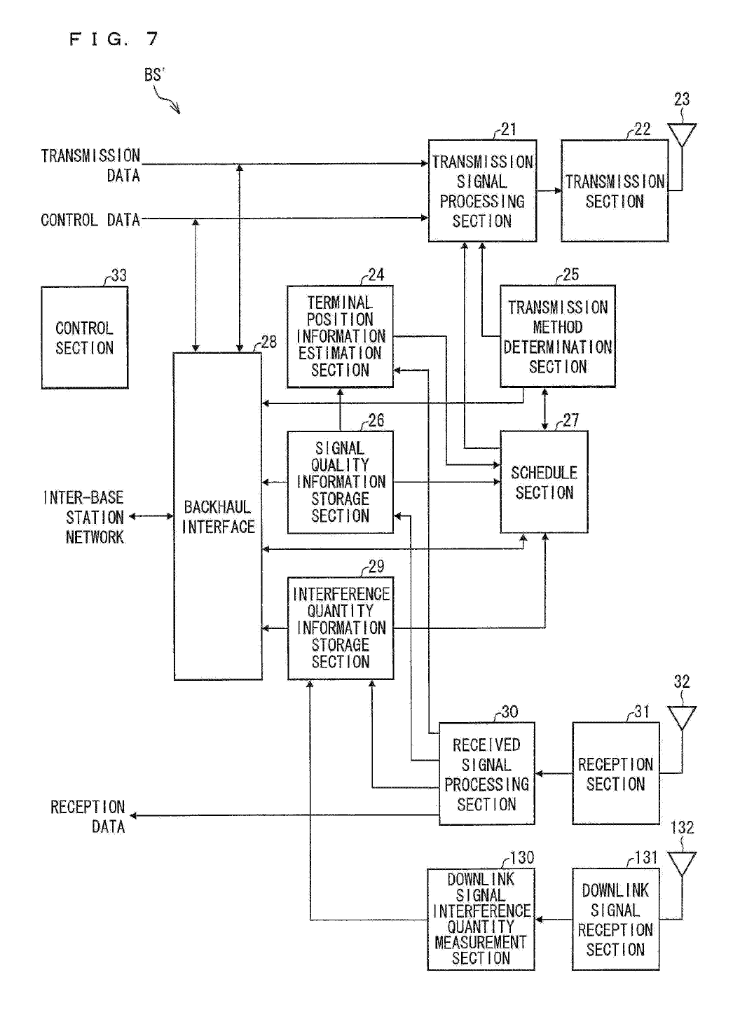

The following describes Third Embodiment of the present invention with reference to FIG. 7. In the present embodiment, identical reference numerals are assigned to members which are common to First and Second Embodiments, and descriptions of such members are omitted here.

FIG. 7 is a block diagram showing a principal configuration of another terminal apparatus BS′ in accordance with the present invention. As shown in FIG. 7, the base station apparatus BS′ further includes a reception antenna 132 for receiving a downlink signal, a downlink signal reception section 131, and a downlink signal interference quantity measurement section 130, in addition to members included in the above-described base station apparatus BS. The base station apparatus BS′ and a terminal apparatus UE′ (having a configuration similar to the terminal apparatus UE) constitute a wireless communication system of the present embodiment.

The signal reception section 131 of the base station apparatus BS′ receives a downlink signal from another base station apparatus BS′ via the reception antenna 132. The signal reception section 131 supplies the downlink signal to the downlink signal interference quantity measurement section 130. The downlink signal interference quantity measurement section 130 compares the downlink signal with a predetermined threshold. In a case where the downlink signal interference quantity measurement section 130 judges, based on the comparison, that a signal level of the downlink signal is greater than the predetermined threshold, the downlink signal interference quantity measurement section 130 concludes that an interference quantity of the downlink signal received from the another base station apparatus BS′ is greater than a reference quantity. A method for creating interference quantity information and operations of members for transmitting the interference quantity information, are identical to those described early, and therefore descriptions of the method and the operations are omitted in this embodiment.

According to the present embodiment, it is possible to omit the measuring of interference quantity in the terminal apparatus UE′. This provides an advantage of further simplifying an operation of the terminal apparatus UE′, as compared with that of the terminal apparatus UE in accordance with First or Second Embodiment. Note that the terminal apparatus UE′ can measure the interference quantity and transmit information on the interference quantity to the base station apparatus BS′, like the terminal apparatus UE doing so. In this case, the base station apparatus BS′ can use the interference quantity information measured by the base station apparatus BS′ itself in combination with the interference quantity information received from the terminal apparatus UE′. This makes it possible to further improve an accuracy in measuring of the interference quantity.

(Additional Matter)

The technical scope of the present invention is defined by claims accompanied with this specification. The technical scope of the present invention should therefore not be limited to the configurations and the like shown in the drawings of the embodiments. Examples of the configuration can be modified as appropriate within a range which allows the effects of the present invention to be brought about. The others can be modified as appropriate, provided that such modifications do not exceed the scope of the object of the present invention.

For example, the embodiments have described in detail a configuration which is on the premise that a cell and an adjacent cell are interfered with each other. However, the technical scope of the present invention is not limited to the configuration. That is, the technical scope of the present invention encompasses a configuration and the like in which a first cell and a third cell, between which a second cell is located, are interfered with each other. Note that the first through third cells are arranged in this order. The present invention is also applicable to a so-called multi-hop system in which a relay station or a remote wireless transmission station is employed.

(Program and Recording Medium)

The sections described in each of the embodiments can be processed, by causing a computer system to read and execute a program stored in a computer-readable recording medium, which program is for realizing the functions of the respective sections described in the embodiments. What is meant by “computer system” includes an operating system and hardware such as peripheral equipment, and can further includes an environment provided (or displayed) by homepages in a case where the computer system utilizes a WWW (World Wide Web) system.

Further, examples of the “computer-readable recording medium” encompass (i) a portable medium such as a flexible disk, a magnetic optical disk, a ROM, or a CD-ROM and (ii) a storage device such as a hard disk incorporated in a computer system. The examples of the “computer-readable recording medium” further encompass a medium, which can dynamically retain a program for a short time period, such as a communication line for transmitting a program via a network such as the Internet or via a communication line such as a telephone line. The examples of the “computer-readable recording medium” further encompass a medium, in which a program is temporarily stored, such as a volatile memory included in a computer system that serves as a server or a client in the network or the communication line. Further, the program can be a program for realizing part of the functions or a program which can be realized in combination with a program already stored in the computer system.

It is preferable to arrange a wireless communication system of the present invention such that the terminal apparatus include:

first measurement means for measuring the interference quantities of the signal transmitted from the another cell; and

transmission means for transmitting information on the interference quantities thus measured to the each of the base station apparatuses,

the storage means storing the interference quantities on the basis of the information on the interference quantities transmitted from the terminal apparatus.

According to the configuration, the terminal apparatus itself measures the interference quantities of the signal thus received. As such, it is possible to obtain accurate information on the interference quantities. This brings about an effect of certainly reducing the interference quantities in the present wireless communication system.

It is preferable to arrange the wireless communication system of the present invention such that the each of the base station apparatuses further include determination means for determining, on the basis of a result set by the setting means, whether to carry out a coordinated multipoint communication among the base station apparatuses.

The configuration can bring about an effect of capable of determining whether to carry out the coordinated multipoint communication by means of a simple process.

It is preferable to arrange the wireless communication system of the present invention such that the each of the base station apparatuses include:

first estimation means for estimating where the terminal apparatus is located; and

determination means for determining, for the respective terminal apparatuses, whether or not the terminal apparatuses carry out coordinated multipoint communication, on the basis of (i) a result set by the setting means and (ii) a result estimated by the estimation means.

According to the configuration, whether to carry out the coordinated multipoint communication is determined in further view of where the terminal apparatus is located. This brings about an effect of capable of further improving an accuracy of the determination.

It is preferable to arrange the wireless communication system of the present invention such that the each of the base station apparatuses further include control means for controlling, on the basis of a result determined by the determination means, electric power with which the signal is transmitted.

The above configuration brings about an effect of capable of adjusting the electric power by which the signal is transmitted to the terminal apparatus by means of a simple process.

It is preferable to arrange the wireless communication system of the present invention such that the storage means store, for respective frequency regions, the interference quantities of the signal transmitted to the terminal apparatus from the another cell,

the notification means notify the information on the interference quantities for the respective frequency regions to the network, and

the setting means set the transmission methods of the signal for the respective frequency regions on the basis of the information on the interference quantities.

The configuration brings about an effect of capable of further minutely controlling the transmission methods by which the signal is transmitted to the terminal apparatus.

It is preferable to arrange the wireless communication system of the present invention such that the each of the base station apparatuses further include second estimation means for estimating the interference quantities of the signal transmitted to the terminal apparatus from the another cell,

the storage means storing information on the interference quantities thus estimated.

According to the configuration, each of the terminal apparatuses itself does not need to measure the interference quantities of the signal. This brings about an effect of capable of alleviating load of processing on the terminal apparatus.

It is preferable to arrange the wireless communication system of the present invention such that the respective frequency regions be respective component carriers in a carrier component aggregation transmission method.

The configuration brings about an effect of capable of reducing information quantity to be exchanged among the base stations, and decreasing load on a backhaul line.

It is preferable to arrange the wireless communication system of the present invention such that the terminal apparatus further include second measurement means for measuring transmission channel situations of the signal for the respective frequency regions, and

the transmission methods be changed for the respective frequency regions just as is the case of measurements of the transmission channel situations of the signal.

According to the configuration, the terminal apparatus transmits information on a signal quality and the information on the interference quantities together to the base station apparatuses. This brings about an effect of capable of reducing quantity of the information on the respective frequency regions.

The embodiments and concrete examples of implementation discussed in the detailed descriptions serve solely to illustrate the technical details of the present invention, which should not be narrowly interpreted within the limits of such embodiments and concrete examples, but rather may be applied in many variations within the spirit of the present invention, provided that such variations do not exceed the scope of the patent claims set forth below.

### INDUSTRIAL APPLICABILITY

The present invention is applicable to various wireless communication systems each of which includes a plurality of cells in each of which a base station apparatus is provided, the base station apparatuses being connected to one another via a network.

### REFERENCE SIGNS LIST

BS: base station apparatus
UE: terminal apparatus
1: reception antenna
2: reception section
3: reception signal processing section
4: interference quantity measurement section (measurement means)
5: interference quantity information creation section
6: signal quality measurement section
7: signal quality information creation section
8: transmission signal processing section
9: transmission section (transmission means)
10: transmission antenna
11: control section
21: transmission signal processing section
22: transmission section (notification means)
23: transmission antenna
24: terminal position information estimation section (estimation means)
25: transmission method determination section (setting means or determination means)
26: signal quality information storage section
27: schedule section (control means)
28: backhaul interface
29: interference quantity information storage section (storage means)
30: reception signal processing section
31: reception section
32: reception antenna
33: control section
130: downlink signal interference quantity measurement section
131: downlink signal reception section
132: reception antenna

1. A wireless communication system, comprising a plurality of cells in each of which a base station apparatus is provided, the base station apparatuses being connected to one another via a network,
each of the base station apparatuses, comprising:
storage means for storing at least information on interference quantities of a signal transmitted, to a terminal apparatus in a corresponding one of the cells in which the each of the base station apparatuses is provided, from another cell different from the corresponding one of the cells;
notification means for notifying the information stored in the storage means to the network; and
setting means for setting, on the basis of the information on the interference quantities, transmission methods by which a signal is transmitted to the terminal apparatus.

2. The wireless communication system as set forth in claim 1, wherein the terminal apparatus includes:
first measurement means for measuring the interference quantities of the signal transmitted from the another cell; and
transmission means for transmitting information on the interference quantities thus measured to the each of the base station apparatuses,
the storage means storing the interference quantities on the basis of the information on the interference quantities transmitted from the terminal apparatus.

3. The wireless communication system as set forth in claim 1, wherein the each of the base station apparatuses further includes determination means for determining, on the basis of a result set by the setting means, whether to carry out a coordinated multipoint communication among the base station apparatuses.

4. The wireless communication system as set forth in claim 1, wherein:
the storage means stores, for respective frequency regions, the interference quantities of the signal transmitted to the terminal apparatus from the another cell,
the notification means notifies the information on the interference quantities for the respective frequency regions to the network, and
the setting means sets the transmission methods of the signal for the respective frequency regions on the basis of the information on the interference quantities.

5. The wireless communication system as set forth in claim 1, wherein:
the each of the base station apparatuses includes:
first estimation means for estimating where the terminal apparatus is located; and
determination means for determining, for the respective terminal apparatuses, whether or not the terminal apparatuses carry out coordinated multipoint communication, on the basis of (i) a result set by the setting means and (ii) a result estimated by the estimation means.

6. The wireless communication system as set forth in claim 3, wherein:
the each of the base station apparatuses further includes control means for controlling, on the basis of a result determined by the determination means, electric power with which the signal is transmitted.

7. The wireless communication system as set forth in claim 1, wherein:
the each of the base station apparatuses further includes second estimation means for estimating the interference quantities of the signal transmitted to the terminal apparatus from the another cell,
the storage means storing information on the interference quantities thus estimated.

8. The wireless communication system as set forth in claim 4, wherein the respective frequency regions are respective component carriers in a carrier component aggregation transmission method.

9. The wireless communication system as set forth in claim 4, wherein
the terminal apparatus further includes second measurement means for measuring transmission channel situations of the signal for the respective frequency regions, and
the transmission methods are changed for the respective frequency regions just as is the case of measurements of the transmission channel situations of the signal.

10. Base station apparatuses, which constitute a wireless communication system, comprising a plurality of cells in each of which a base station apparatus is provided, the base station apparatuses being connected to one another via a network,
each of the base station apparatuses, comprising:
storage means for storing at least information on interference quantities of a signal transmitted, to a terminal apparatus in a corresponding one of the cells in which the each of the base station apparatuses is provided, from another cell different from the corresponding one of the cells;
notification means for notifying the information stored in the storage means to the network; and
setting means for setting, on the basis of the information on the interference quantities, transmission methods by which the signal is transmitted to the terminal apparatus.

11. A terminal apparatus, for use in a wireless communication system which comprises a plurality of cells in each of which a base station apparatus is provided, the base station apparatuses being connected to one another via a network,
the terminal apparatus, comprising:
measurement means for measuring interference quantities of a signal transmitted from another cell different from a cell in which the terminal apparatus is provided; and
transmission means for transmitting information on the interference quantities thus measured to a corresponding one of the base station apparatuses.

12. A method for controlling a wireless communication system which comprises a plurality of cells in each of which a base station apparatus is provided, the base station apparatuses being connected to one another via a network,
said method comprising the steps of:
storing information on interference quantities of a signal transmitted from another cell different from a cell in which the terminal apparatus is provided;
notifying the information stored in the storage means to the network; and
setting, on the basis of the information on the interference quantities, transmission methods by which the signal is transmitted to the terminal apparatus.

13. A program for causing a computer to execute a method recited in claim 12.

14. A computer-readable recording medium in which a program recited in claim 13 is stored.
